(19) United States
(12) Patent Application Publication
(10) Pub. No.: US 2026/0216938 A1
(43) Pub. Date: Jul. 30, 2026

(54) DIE PLATE ASSEMBLY FOR A PELLETISING APPARATUS, AND A PELLETISING APPARATUS HAVING SAME

(71) Applicant: Nordson Corporation, Westlake, OH (US)

(72) Inventors: Heinrich HUBERT, Greven (DE); Philipp KLARICIC, Telgte (DE)

(21) Appl. No.: 19/146,053

(22) PCT Filed: Jan. 11, 2024
(86) PCT No.: PCT/US2024/011145

§ 371 Date: Jul. 7, 2025

(30) Foreign Application Priority Data
Jan. 13, 2023 (DE) 10 2023 100 777.7

(51) Int. Cl. B29C 48/345; B29C 48/04; B29C 48/86

(52) U.S. Cl. CPC B29C 48/345; B29C 48/04; B29C 48/865

(57) ABSTRACT

A die plate assembly includes at least one inlet arranged on a melt inlet side for feeding in melt, and a plurality of outlets arranged on a melt outlet side for dispensing the melt. The die plate assembly in addition includes a melt conveying zone having at least one and preferably a plurality of melt flow channels extending from the melt inlet side to the melt outlet side. The assembly moreover includes where the melt conveying zone is designed as a melt conveying part which is separable from the die plate assembly and can be reversibly mounted on and dismantled from the die plate assembly.

### CROSS-REFERENCE TO RELATED APPLICATIONS

This application claims the benefit of German Patent Application No. 102023100777.7 filed on Jan. 13, 2023, which is hereby incorporated by reference in its entirety for all purposes as if fully set forth herein.

### FIELD OF THE DISCLOSURE

The invention relates to a die plate assembly for a pelletizing apparatus for producing granulate from liquid plastic melt, in particular from a thermoplastic material, comprising at least one inlet arranged on a melt inlet side for feeding in melt, and a plurality of outlets arranged on a melt outlet side for dispensing the melt, a melt conveying zone having at least one and preferably a plurality of melt flow channels extending from the melt inlet side to the melt outlet side. The invention also relates to a melt conveying part for conveying a melt, a pelletizing apparatus for producing granulate from melt and a method for repairing a pelletizing apparatus having a die plate assembly.

### BACKGROUND OF THE DISCLOSURE

Such die plate assemblies are known from the prior art and are used in pelletizers, for example. They are predominantly used to extrude a liquid plastic melt, for example a thermoplastic, by means of their melt conveying zone into a plurality of melt strands, in most cases. In underwater pelletizing, the individual melt strands produced are divided into strand sections by a cutting device after they pass through the melt conveying zone. As a cooling medium, such as water, flows along the outlet side of the die plate assembly, the melt strands exiting from the outlet side come into contact with the cooling medium and the divided strand sections, which form granulate, are cooled down in the cooling medium. Underwater pelletizing achieves a high level of efficiency in the production of plastic granulate from liquid plastic melt.

In die plate assemblies known from the prior art, the liquid plastic melt is fed via an inlet into a die plate body, in particular into its melt conveying zone. By means of preferably a plurality of flow channels inside the melt conveying zone of the die plate body, the liquid plastic melt is divided into a number of melt strands corresponding to the plurality of flow channels present in the melt conveying zone. On the melt outlet side, there is a plurality of outlets in the die plate body for dispensing the melt, the size of which can vary according to the plastic melt to be processed. Due to the large number of outlets, die plate assemblies known from the prior art show high productivity in the production of plastic granulate, even with a relatively small granule size.

In the production of plastic granulate, the die plate assemblies are subject to continuous wear due to the relatively high pressures in granulate production and due to the cutting device that is moved continuously along the melt outlet side. By reconditioning such a die plate assembly at least once, it can be reused for a further period of processing. The number of times that die plate assemblies known from the prior art can be reconditioned is limited, however. After a certain number of reconditions or operating hours, the predominantly integral die plate assembly is ultimately worn out and has to be replaced. The melt conveying zone is usually fixed with a middle part adjoining the melt conveying zone on the inner side and an outer region adjoining the melt conveying zone on the outer side. The adjoining outer and middle regions give die plate assemblies known from the prior art their high structural strength.

Regular replacement of a die plate assembly therefore involves correspondingly high material and labor costs, which basically makes the production of such die plate assemblies very cost intensive. Even if die plate assemblies known from the prior art can be reconditioned several times, such a reconditioning process nevertheless involves a correspondingly large amount of labor, because known die plate assemblies have diameters between 200 and 800 mm and can therefore weigh more than 100 kg, which makes them more difficult to handle.

Given this background, the object of the invention is to present a die plate assembly for a pelletizing apparatus, a pelletizing apparatus for producing granulate and a method for repairing a pelletizing apparatus, with which the disadvantages found in the prior art are resolved as far as possible. In particular, a die plate assembly, a pelletizing apparatus and a method for repairing a pelletizing apparatus are specified that can be manufactured in a simple and inexpensive manner and which allows simplified handling when repairing a die plate assembly.

### SUMMARY OF THE DISCLOSURE

According to the invention, the object is achieved by the features of claim 1 in a die plate assembly of the kind initially specified. In particular, the melt conveying zone is designed as a part which is separable from the die plate assembly and can be reversibly mounted on and dismantled from the plate assembly die plate assembly.

The approach pursued, according to the invention, is to provide the melt conveying zone, which is subject to continuous wear and tear during extrusion of the plastic melt, as a separately embodied part on the die plate assembly, in particular on its die plate body, instead of providing an integral die plate assembly. Such a melt conveying part of the die plate assembly can thus be reversibly mounted on the die plate assembly and dismantled from it. When the need arises, it can be simply replaced on a die plate assembly according to the invention and reused on the die plate assembly after reconditioning that is accordingly simplified, or replaced by a completely new melt conveying part.

Manufacturing such a die plate assembly thus involves significantly reduced material and cost expenditure, and such a die plate assembly according to the invention allows a pelletizing apparatus to be repaired and maintained more simply. The die plate assembly, or the die plate body of the die plate assembly, thus has a replaceable melt conveying part that now forms, on the die plate assembly, the melt inlet side for the liquid plastic melt, the melt outlet side with its plurality of outlets provided thereon for dispensing the plastic melt in the form of melt strands, and the flow channels extending from the melt inlet side towards the melt outlet side.

According to a preferred development of the die plate assembly according to the invention, such a die plate assembly is formed by at least the melt conveying part and a middle part and/or an outer ring, wherein the melt conveying part can be releasably coupled to the middle part and/or the outer ring. In addition to the melt conveying part, the die plate assembly has at least an outer ring adjoining the melt conveying zone on the outer side and/or a middle part adjoining the inner side of the melt conveying part. The outer ring adjoining the melt conveying part on the outer side is preferably used to mount the die plate assembly on a die plate holder associated with the pelletizing apparatus, in particular on a start-up valve. Smaller die plate assemblies can also be mounted on the pelletizing apparatus itself. The middle part engaging the inner side of the melt conveying part is used, in particular, to distribute the liquid plastic melt flowing towards the melt inlet side of the die plate assembly onto a substantially annular inlet region of the die plate assembly. The inlet region extends substantially in a circular manner around the center axis of the die plate body, in particular.

The melt conveying part is preferably substantially annular in shape, and the flow channels are preferably spaced apart from each other on at least one circle. The annular design of the melt conveying part results in a design that above all is constructionally simple and which allows, with its flow channels arranged on a circle, a relatively high material throughput through the melt conveying part embodied in accordance with the invention.

In one embodiment of the die plate according to the invention, multiple outlets per flow channel may be formed on differently sized circles on the melt conveying part. Such a melt conveying part according to the invention can thus have multiple rows of outlets per flow channel, which are spaced radially apart from each other.

According to a preferred embodiment of the invention, the outer ring of the die plate assembly has a receiving section for the melt conveying part to be positioned relative to the outer ring. With the aid of the receiving section, the melt conveying part is securely accommodated on the outer ring of the die plate assembly, wherein the receiving section holds the outer ring and melt conveying part to each other in the direction of flow of the liquid plastic melt. In the simplest embodiment, the receiving section on the outer ring has one or more retention regions which can be brought into contact with the melt conveying part and which prevent at least any relative movement of the outer ring and the melt conveying part in a direction parallel or radial to the flow channels running in the melt conveying part.

In a preferred embodiment, the receiving section for the melt conveying part can be accessed from the melt inlet side or the melt outlet side. The advantage of providing the receiving section for the melt conveying part on the outer ring and on the melt inlet side of the die plate assembly is that the pressure acting in the flow direction of the plastic melt can be safely absorbed by the outer ring holding the melt conveying part and can be dissipated into the structure reinforcing the die plate assembly. The advantage of providing the receiving section on the melt outlet side, in contrast, is that the melt conveying part formed separately from the outer ring in accordance with the invention can be removed from the die plate assembly according to the invention when the die plate assembly is still mounted on a pelletizing apparatus, which further improves handling, particularly when repairing such a die plate assembly according to the invention.

According to one embodiment, in order to form the receiving section the outer ring also has a preferably stepped recess with a stop face for the melt conveying part extending approximately in the radial direction. A central recess for receiving the melt conveying part insertable therein is preferably provided on the outer ring, the outer ring having at least one stop face radially protruding in the direction of insertion of the melt conveying part, with which the separately formed melt conveying part comes into contact when inserted into the outer ring. A preferably circumferential, stepped recess may preferably be provided as a receiving section on the outer ring. In an alternative embodiment, there is a recess with steps that are spatially interrupted in the circumferential direction of the outer ring.

To obtain a form-fitting connection between the outer ring and the melt conveying part which acts in the direction of flow, in particular, at least one preferably circumferential projection projecting radially outwards and having an abutment face matching the stop face on the outer ring is formed on the melt conveying part. The recess on the outer ring and the projection on the melt conveying part engage form-fittingly with each other, thus resulting in a locking function when the melt conveying part is inserted into the outer ring in the longitudinal direction of the flow channels. In one preferred embodiment, the recess on the outer ring and the projection(s) on the melt conveying part are designed to also cause the melt conveying part and the outer ring to lock into each other in the circumferential direction relative to one another.

According to an alternative embodiment, the outer ring has a receiving surface tapering conically from the melt inlet side towards the melt outlet side to form the receiving section. By providing a receiving cone on the outer ring to form the receiving section, the surfaces of the outer ring and the melt conveying part to be brought into contact with each other converge with each other when the separately embodied melt conveying part is inserted. In addition to the form-fitting connection produced by the decreasing diameter of the receiving cone, the parts of the die plate assembly are radially centered in relation to each other between the surfaces converging with each other. A kind of self-locking mechanism for locking the melt conveying part is also provided on the outer ring of the die plate assembly.

The melt conveying part preferably has an abutment face tapering conically from the melt inlet side towards the melt outlet side and defining a section on the outer circumference, and which matches the receiving surface on the outer ring. In addition to the locking action in the longitudinal direction of the flow channels, a sealing effect is also produced between the receiving cone on the outer ring and the outer circumference tapering conically in sections. The conically tapering surfaces on the outer ring and on the melt conveying part are preferably formed only along a section running parallel to the longitudinal axis of the outer of the outer ring and the melt conveying part, respectively. In addition to the axial locking of the melt conveying part and the outer ring in relation to each other, the melt conveying part is also aligned radially inside the receiving section on the outer ring.

In another optional or alternative embodiment of the die plate assembly according to the invention, the receiving section on the outer ring is designed as a rotary plug connection having at least one groove-like indentation extending in the circumferential direction, and an axially open insertion region for a locking part on the melt conveying part, for insertion into the indentation via the insertion region. In addition to axial positioning of the outer ring and the melt conveying part relative to each other, the melt conveying part is also positioned simultaneously and advantageously in the circumferential direction relative to the outer ring by means of the rotary plug connection. By means of the groove-like indentation preferably extending in the circumferential direction to a limited extent, a kind of stop face is formed for the locking part to be inserted therein. The direction of rotation of the rotary plug connection in the circumferential direction, and the resultant stop function corresponds to or is preferably identical to the rotational direction of a cutting head that cooperates with the die plate assembly.

To form the locking part, the melt conveying part preferably has at least one projection spaced axially apart from the melt inlet and melt outlet side of the melt conveying part and projecting radially from the outer circumference and extending circumferentially along a section. A multi-part die plate body formed with such a rotary plug connection can be used, in particular, to configure the receiving section that is accessible from the melt outlet side. The form-fittingly interlocking material regions of the melt conveying part and the outer ring form a structural connection of the reversibly mountable and dismantlable parts of the die plate assembly to each other that is secure and above all resistant to the pressures generated during production of the plastic granulate. A plurality of such projections are preferably arranged along the outer circumference of the melt conveying part, and in order to ensure that it has the necessary strength on a die plate assembly according to the invention, such a projection has a parallel thickness in the longitudinal direction of the flow channels equal to about a third to about half of the total thickness of the die plate body from the melt inlet side to the melt outlet side.

In another preferred development of the die plate assembly according to the invention, form-fitting elements that form-fittingly match each other are respectively formed as positioning means at an insertion region and at a projection matching the insertion region, by means of which a preferred orientation is defined when assembling the melt conveying part and the outer ring into each other. The form-fitting elements provided only at one insertion region and one projection prevent any incorrect assembly of the melt conveying part and the outer ring relative to each other. If, in a preferred embodiment, heating pipes for conducting a medium extend radially from the outside through the outer ring into the melt conveying part, the flow of fluid through the melt conveying part is ensured by the correctly assembled parts of the die plate assembly.

According to another preferred embodiment of the die plate assembly according to the invention, matching recesses are provided on the outer ring and on the melt conveying part, which are axially aligned with one another and are arranged to fix the outer ring and the melt conveying part to one another when the die plate assembly is in the operating mode. By means of the recesses in the outer ring and/or melt conveying part, some of which are preferably formed as threaded holes, a firm and secure connection is achieved between the two components of the die plate according to the invention that are to be joined together. They can also be disconnected again by loosening the fastening means that are accommodated in these recesses in the outer ring and the melt conveying part. A reversibly releasable connection is preferably produced between the melt conveying part and the outer ring, such that the melt conveying part can be reversibly mounted on and dismantled from the die plate assembly according to the invention. Depending on the configuration of the recesses in the melt conveying part and/or the outer ring, these may have threaded sections, wherein axially adjacent sections of the recess in the respective other component have diameters which are larger than the outer diameter of the fastening means to be inserted therein, so as to ensure the clamping effect between the components to be connected to each other.

According to another preferred embodiment of the die plate assembly according to the invention, the melt conveying part and/or the outer ring has at least one heating channel offset radially inwardly and/or outwardly relative to the melt flow channels, for conveying a heat medium therethrough, or a heating conductor receptacle for inserting an electrical heating conductor. By means of the at least one heating channel preferably formed adjacent to the flow channels in the melt conveying part, the die plate assembly is heated so that the liquid plastic melt can preferably be kept at the desired temperature and thus in a free-flowing state during normal operation. In combination with embodiments described further below (air gap, and forming the melt conveying part, outer ring and/or middle part from materials with different coefficients of thermal conductivity), the thermal conductivity in the direction of the outer ring and the middle part can be further reduced, such that the heat input via the melt conveying part alone is preferably sufficient during normal operation. Due to the multi-part nature of the die plate assembly, energy savings are achieved during operation of the pelletizing apparatus. In one preferred embodiment of the invention, the outer ring may be fitted with one or more heating channels for heating up the die plate assembly faster during start-up of the pelletizing process and which is/are preferably supplied with a fluid gas or liquid heat medium. Alternatively, an electric heating conductor may also be arranged in the heating channel(s) in the outer ring. A heater strip can also be wrapped around the outer ring during start-up.

The heating channel preferably extends in the melt conveying part along a section of the melt flow channels, wherein the heating channel is assigned to the outlet end of the flow channel. The heating channel adjacent to the flow channels in the melt conveying part allows efficient heat input into the adjacently arranged flow channels and thus into the plastic melt passing through the flow channels. A heating channel, or parts of a single heating channel, is preferably offset radially inwards and also radially outwards in relation to the flow channels. This further improves the heat input into the flow channels of the separately formed melt conveying part.

According to a preferred embodiment of the die plate assembly, the heating channel is an annular space and the melt conveying part has at least one inlet for the heat medium flowing into the heating channel and at least one outlet for the heat medium flowing out of the heating channel. The heating channel or parts thereof preferably extend as an annular space along the flow channels arranged on a circle on the melt conveying part. Such an annular space, inside which the heat medium for heating the melt conveying part flows, is preferably formed both on the inner side and also on the outer side relative to the flow channels.

In order to improve the transfer of heat to the plastic melt flowing through the flow channels, the inner and outer heating channels are in fluid communication with each other, preferably via radially extending connecting channels. In one embodiment, the heating channel also has an inlet that extends radially, in particular, and at least one radially extending outlet, which are preferably formed on opposite regions of the melt conveying part. In one preferred embodiment, the heating channel has two outlets for discharging the heat medium, which are arranged at an angle of approximately 35° bis 55° to each other on the circumferential region of the melt conveying part approximately opposite the inlet.

According to the present invention, the melt conveying part has at least one base member surrounding the flow channels and at least one separately embodied, approximately cylindrical sleeve member which delimits at least one inner and/or outer wall region of the melt conveying part and preferably defines the outer wall of the heating channel or one of the heating channels. With the aid of the sleeve member to be separately arranged on the base member with its flow channels, the outer wall regions in particular of the heating channel are delimited, which simultaneously define an inner and/or outer wall region of the melt conveying part. A sleeve member performing the dual function described above is preferably arranged on the inner side and on the outer side of the base member. The sleeve parts have different diameters.

Each sleeve member is preferably connected sealingly or in a material fit to the adjacent regions of melt conveying part, in particular of its base member. This functions as a seal between the contact surfaces of the sleeve member and the base member of the melt conveying part, thus ensuring that the heat medium is securely retained within the heating channel spatially delimited by the sleeve members. A welded connection is the preferred material-fit connection between the sleeve member and the melt conveying part. A sealing function can also be achieved with the aid of a sealing element arranged on the base member of the melt conveying part, for example, and which is compressed by a cooperating contact surface of the sleeve member, thus achieving the sealing effect between the components to be connected to each other.

According to a preferred embodiment of the present invention, the melt conveying part is subdivided into at least two separate segments, preferably ring segments. Instead of a single melt conveying part in the shape of annular member, the latter can be subdivided into two, three or more segments. This has the advantage that only sections of the melt conveying part of the die plate assembly according to the invention need to be replaced, when the need arises, rather than the entire melt conveying part, for example when a sudden defect occurs in one segment of the melt conveying part, such that parts of the melt conveying part have to be replaced prematurely. The two, three or more segments are positioned, like pieces of a cake, in such a manner relative to each other on at least the outer ring of the die plate assembly that the end faces of the segments come into contact with each other and are preferably sealed against each other in such a way that the flowing plastic melt does not get between the end faces of the adjacently arranged segments of the melt conveying part. Alternatively, the melt conveying part can also be designed as a single segment having a radially extending separation slit similar to a Seeger circlip ring.

In a preferred embodiment of the die plate assembly according to the invention, each segment has at least one connection port as an inlet to the heating channel and at least one further connection port as an outlet from the heating channel, wherein radially extending recesses are preferably provided in the outer ring on the melt inlet side. To ensure the necessary heat input in the region of its flow channels, each segment of the melt conveying part has an inlet as an entry point for the heat medium and at least one outlet as an exit point for the heat medium. The connection ports are preferably arranged at opposite ends of the segments to allow efficient heat transfer of the heat energy contained in the heat medium to the melt conveying part and to the plastic melt flowing through the melt conveying part.

Radially extending recesses accessible from the melt inlet side are preferably provided on the outer ring, instead of through holes extending purely in the radial direction, for inserting heating pipes for the heat medium that are to be connected to the segments. A segment with its pre-assembled heating pipes can thus be inserted easily from the melt inlet side into the section provided for that purpose on the outer ring.

The melt conveying part preferably has a receptacle for holding the middle part on the melt conveying part, wherein the middle part can preferably be assembled from a plurality of individual parts. Via the receptacle on the melt conveying part, the middle part of the die plate body can be securely received on the melt conveying part formed separately from the middle part, and securely connected thereto. In one possible embodiment of the die plate assembly, the receptacle preferably provided for the middle part on the inner side of the melt conveying part is cylindrical.

According to a preferred development of the invention, the receptacle for the middle part can be accessed from the melt outlet side and has at least one stepped recess with a radially extending receiving surface for the middle part. By means of the stepped recess and its substantially radially extending and circumferential receiving surface, a receptacle for the middle part on the melt conveying part is provided that is constructionally simple to manufacture and which provides a perfect fit. The middle part is preferably inserted from the melt outlet side into the receptacle provided for that purpose on the melt conveying part. This makes it easier for the die plate assembly according to the invention to be mounted on and dismantled from a pelletizing apparatus.

The middle part preferably has a preferably circumferential projection projecting radially outwards and having an abutment face matching the receiving surface on the melt conveying part. The middle part, with its radially protruding projection on its outer circumference, is designed in particular for form-fitting abutment against the receiving surface of the melt conveying part, so when the middle part is brought into contact with the melt conveying part, the middle part is automatically positioned relative to the melt conveying part. The middle part is positioned, in particular, in the axial direction of the die plate assembly.

According to one possible embodiment of the die plate assembly according to the invention, the middle part is composed of a substantially cylindrical base member and a guide cone connectable to the base member, the middle part having at least one alignment element for the guide cone to be received on the base member. The base member and guide cone forming the middle part are brought into contact with sections of the melt conveying part from opposite sides of the die plate body (the melt inlet side and the melt outlet side). The components of the middle part that engage in this manner are connected to each other and produce a clamping effect on the section of the melt conveying part received between them. The guide cone is preferably fastened on the base member using an alignment element, such that the longitudinal axes of the base member and the guide cone align with each other.

In one possible embodiment of the die plate assembly, a preferably circumferential air gap is formed at least in sections between the outer ring and the melt conveying part and/or between the melt conveying part and the middle part. The air gap, which preferably extends along an axial section between the surfaces of the outer ring, melt conveying part and middle part that can otherwise be brought into contact with each other, improves the insulation of the components to be joined together. That suffices in this embodiment, as the transfer of heat towards the components of the die plate assembly that are connected to the melt conveying part is so minimized that only the melt conveying part is supplied via the heating channel formed thereon with heat energy for keeping the melt in a liquid state. To form the air gap, an indentation/recess may be partly formed on the inner and outer wall of the melt conveying part or on the walls of the outer ring and middle part facing the melt conveying part.

According to a possible development of the die plate assembly, the outer ring and/or the middle part and preferably the at least one sleeve member is/are made of a material which has a low coefficient of thermal conductivity relative to the material used to form the melt conveying part. The specific embodiment of the die plate assembly according to the invention using materials having different coefficients of thermal conductivity allows the transfer of heat from the region around the melt conveying part of the die plate assembly to be minimized and the insulation effect to be further improved. The middle part and the outer ring, as well as the sections of the sleeve members forming sections of the inner and outer wall at the melt conveying part may preferably consist of materials that have insulating properties in comparison with the melt conveying part, which preferably consists of a metal material. This advantageously reduces the heat input and thus the amount of energy required to keep the plastic melt to be conducted through the die plate assembly according to the invention in a free-flowing state. The embodiment of the die plate assembly according to the invention thus helps to minimize the amount of energy needed to produce granulate.

According to another possible embodiment, the melt conveying part is produced using an additive manufacturing method, in particular a three-dimensional printing method. Production using an additive manufacturing method allows the melt conveying part to be designed as an integral component that preferably has all its constructional features, such as shoulders, undercuts, flow channels extending from the melt inlet side to the melt outlet side, and the annular heating channels arranged adjacent to the flow channels, when the component has been produced. The melt conveying part can be produced without subsequent machining, although this is not precluded. Alternatively, the melt conveying part can be produced using a casting process. Additive manufacturing can be used to produce integral members having closed cavities and small distances between the heating channel(s) to the melt flow channels, in particular inside the member, and whose structural stability is improved in comparison with a member composed of individual parts, and whose weight is minimized for easier handling.

A further aspect of the present invention relates to a melt conveying part for conveying a melt, in particular of thermoplastic material, for a die plate assembly of a pelletizing apparatus, in particular for a die plate assembly according to at least one of the preferred embodiments described above. The melt conveying part according to the invention likewise achieves the object of the die plate assembly, by being designed as a separate component comprising a melt inlet side and a melt outlet side, and a plurality of flow channels extending from the melt inlet side to the melt outlet side, wherein abutment faces are provided on the melt conveying part for an outer ring which can be brought reversibly into contact with the outer side of the melt conveying part and/or for a middle part of a die plate assembly, which can be brought reversibly into contact with the inner side of the melt conveying part.

The separately embodied melt conveying part according to the invention results in a multi-part embodiment of a die plate assembly fitted therewith, which advantageously affects the assembly and dismantling of the die plate assembly on a pelletizing apparatus in the event of potential repair work having to be carried out on the latter. Thus, instead of dismantling and replacing the entire die plate assembly on the pelletizing apparatus, only parts of the die plate assembly need to be dismantled, including the melt conveying part and the middle part of the die plate assembly connected thereto, if necessary while the outer ring is still mounted on the pelletizing apparatus. Reconditioning and replacing, if necessary, the melt conveying part on the die plate assembly according to the invention is also simplified, and is possible with significantly reduced material and cost expenditure. The outer ring and the middle part of a die plate body according to the invention can also still be used in combination with a reconditioned or new melt conveying part. By means of the abutment faces preferably provided on the outer side and inner side of the melt conveying part, the melt conveying part can be brought into contact with an outer ring of the die plate assembly and/or with the middle part of the die plate assembly, or separated therefrom, above all in a simple and reversible manner. The insulation of the melt conveying part from the outer ring and/or middle part is also improved by preferably providing, section-wise, an air gap to the outer ring and/or middle part to be brought into contact with the melt conveying part. This means that the heat input by means of the heat transfer medium, to keep the melt passing through the melt conveying part in a liquid state can preferably be confined to the region of the melt conveying part. To that end, an indentation or recess may be partly formed on the inner and outer wall of the melt conveying part or on the walls of the outer ring and middle part facing the melt conveying part.

The melt conveying part for such a die plate assembly according to the invention makes use of the same advantages and preferred developments as the die plate assembly according to the invention, and vice versa.

A third aspect of the invention relates to a pelletizing apparatus for producing granulate from melt, in particular from thermoplastic material, comprising a die plate assembly that conveys the melt. The pelletizing apparatus is characterized in that the die plate assembly is embodied according to any one of the preferred embodiments described above. The invention makes use of the discovery that the melt conveying zone known from the prior art can now be embodied as an individual part that is separately formed on the die plate assembly. According to this third aspect, the die plate assembly comprises a multi-part die plate body comprising at least an outer ring, the separate melt conveying part and a middle part, also separately embodied, which can be reversibly separated from each other and reassembled to form a die plate body.

In yet another aspect, the invention relates to a method for repairing a pelletizing apparatus having a die plate assembly, in particular a pelletizing apparatus according to the preferred embodiment described above, comprising the steps of: at least partly dismantling the die plate assembly, replacing at least a melt conveying part or segment of the die plate assembly, and mounting at least the part of the die plate assembly fitted with a new melt conveying part or segment to a die plate holder or to the pelletizing apparatus, wherein parts of the die plate assembly are dismantled and mounted from its melt outlet side.

The steps of the method according to the invention allow a pelletizing apparatus fitted with a die plate assembly according to the invention to be repaired more easily. It is preferable that, when repairing the die plate assembly, only parts of it are dismantled and that, after replacing a defect or used segment or the entire melt conveying part, it is only necessary to mount a newly fitted part to the die plate assembly that is still attached at least partly to a die plate holder, for example, or to the pelletizing apparatus. In one variant of a method according to the invention, the entire die plate assembly is dismantled from a die plate holder, and the melt conveying part or parts thereof are then dismantled from the removed die plate assembly and replaced. Replacing the melt conveying part can preferably be done from the melt inlet side when a die plate assembly has been fully dismantled.

The preferred embodiments and developments described for the die plate assembly or the melt conveying part are also preferred embodiments of the pelletizing apparatus according to the invention and of the method for replacing a pelletizing apparatus having a die plate assembly. Preferred embodiments and developments of the pelletizing apparatus and of the method described herein which relate to the die plate assembly or to the melt conveying part are also preferred embodiments of the die plate assembly or of the melt conveying part itself.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

Further features and advantages of the invention shall now be described with reference to a preferred embodiment and the attached Figures, and can also be seen from the embodiments detailed below.

### BRIEF DESCRIPTION OF THE DRAWINGS

FIG. 1 shows a perspective view of an embodiment of a pelletizing apparatus having a die plate assembly according to the invention;

FIG. 2 shows a perspective view of a first embodiment of a die plate assembly according to the invention having heating pipes connected thereto;

FIG. 3 shows a perspective view of a first embodiment of a melt conveying part according to the invention as shown in FIG. 1;

FIG. 4 shows a partial cross-sectional view of the die plate assembly according to the invention as shown in FIG. 1;

FIG. 5 shows a partial cross-sectional view of another embodiment of a die plate assembly according to the invention;

FIG. 6 shows a partial cross-sectional view of another possible embodiment of a die plate assembly;

FIG. 7 shows a partial view of an embodiment of a melt conveying part of the die plate assembly shown in FIG. 6;

FIG. 8 shows a view of another embodiment of a die plate assembly according to the invention, with heating pipes connected thereto;

FIG. 9 shows a partial section through part of the die plate assembly according to the invention as shown in FIG. 8;

FIG. 10 shows a perspective view of the embodiment of the melt conveying part shown in FIGS. 8 and 9;

FIG. 11 shows a perspective view of another embodiment of a die plate assembly according to the invention;

FIG. 12 shows a separate perspective view of a melt conveying part of the die plate assembly according to the invention as shown in FIG. 11;

FIGS. 13 and 14 show perspective views from the melt inlet side and the melt outlet side of another embodiment of a die plate assembly according to the invention, having an embodiment of a melt conveying part;

FIGS. 15 and 16 show schematic cross-sectional views of an embodiment of a melt conveying part portion according to the invention, in order to show its structure, and

FIG. 17 shows a schematic view, in the form of a block diagram, of a method according to the invention for repairing a pelletizing apparatus.

### DETAILED DESCRIPTION

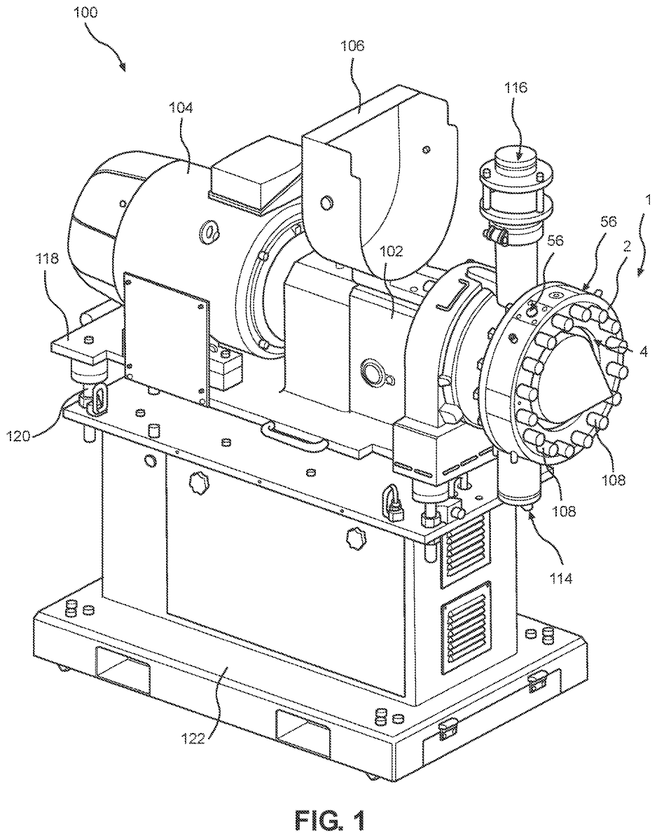

FIG. 1 shows a pelletizing apparatus 100 which is designed here and preferably as an underwater pelletizing apparatus. The inventive embodiments of die plate assemblies 1, 1′ described below can also be used on other pelletizing apparatuses, of course. Pelletizing apparatus 100 has an underwater pelletizer 102 that is driven by a drive means 104. A protective cover 106 is also provided on the pelletizing apparatus.

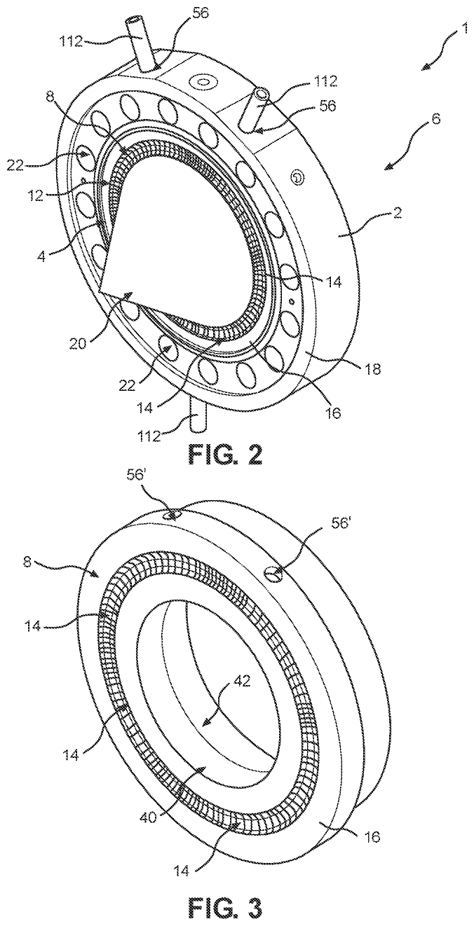

Pelletizing apparatus 100 also has a die plate assembly 1 that is associated with underwater pelletizer 102 and to which liquid plastic melt is normally fed by means of an extruder not shown in the Figures. Die plate assembly 1, which is mounted, for example by means of a plurality of fixing screws 108, on a die plate holder, not shown, is heated via inlets and outlets 56 in the form of connection ports for a heat medium which is fed via heating pipes 112 (FIG. 2) in die plate assembly 1.

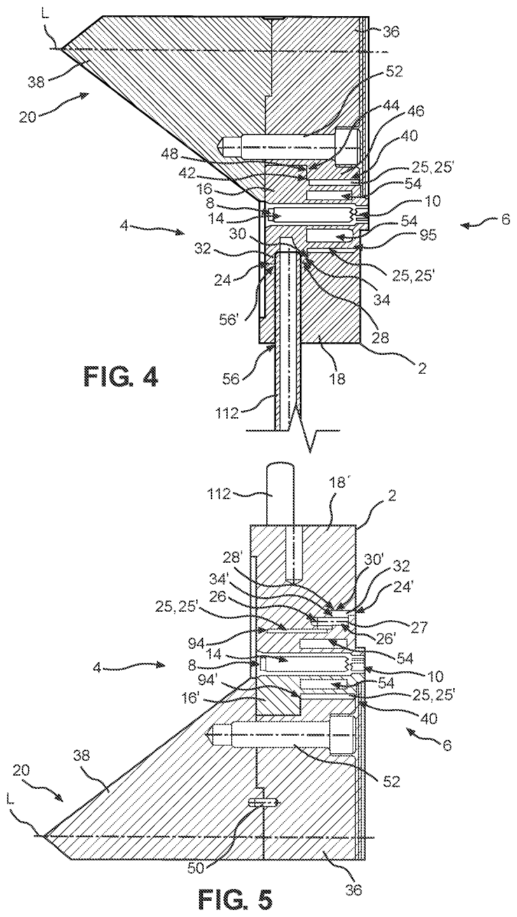

Underwater pelletizer 102 has a process water inlet 114 and a process water outlet 116 via which process water is fed to and discharged from a melt outlet side 6 of die plate assembly 1 according to the invention. When pelletizing apparatus 100 is in operation, plastic melt enters die plate assembly 1, shown in FIG. 1, on the melt inlet side 4 of die plate body 2, is divided into a plurality of plastic strands inside die plate body 2 and exists as continuously flowing melt strands on melt outlet side 6 (FIG. 4). Underwater pelletizer 102 further comprises a cutting device, not shown, which moves along the melt outlet side of die plate body 2 and continuously divides the exiting melt strands into individual strand sections.

In one embodiment, not shown, the cutting device of underwater pelletizer 102 has a rotating cutting head with a plurality of cutting blades arranged thereon. In underwater pelletizer 102, the exiting melt strands/separated strand sections come into contact with and are cooled by the process water, and the separated strand sections are discharged from the underwater pelletizer via process water outlet 116 and separated from the process water in a separate process step.

Drive means 104 is used to drive the cutting device, not shown, in particular to impart a rotational movement to the cutting device and its cutting blades. The assembly comprising at least underwater pelletizer 102 and drive means 104 is mounted on a machine base 118 which is arranged on a movable housing structure 122 via spacer elements 120.

FIG. 2 shows a possible embodiment of a die plate assembly 1 as shown in FIG. 1, but separated from pelletizing apparatus 100. Die plate assembly 1 includes a die plate body 2, which has a melt inlet side 4 and a melt outlet side 6 on the opposite side from melt inlet side 4. Melt inlet side 4 has at least one inlet 8 for feeding melt into die plate assembly 1. A plurality of outlets 10 (FIG. 4) for dispensing the melt are arranged on melt outlet side 6.

Die plate assembly 1 also has a melt conveying zone 12, which in the embodiment shown here has a plurality of flow channels 14 for the plastic melt that extend from melt inlet side 4 towards melt outlet side 6. On die plate body 2, the outlets 10 at each end of a respective flow channel 14 are arranged so that the plastic melt leaves die plate body 2 as a plurality of melt strands that are fed to the underwater pelletizer 102 for subdivision into strand sections.

According to the invention, melt conveying zone 12 is embodied as a melt conveying part 16 separable from die plate assembly 1, in particular from die plate body 2. Melt conveying part 16 can thus be reversibly mounted on and dismantled from die plate body 2. In addition to melt conveying part 16, die plate assembly 1 has an outer ring 18 and a middle part 20. Die plate body 2 is therefore a multi-part component.

By means of outer ring 18, die plate assembly 1 is connected to the die plate holder, not shown. A plurality of screw holders 22 for the fixing screws 108 shown in FIG. 1 are provided for that purpose on outer ring 18. The inlets and outlets 56 for heating pipes 112, formed as connection ports on die plate assembly 1, can also be seen. The plastic melt is distributed by means of middle part 20 onto the circular inlet 8 on the melt inlet side 4 of die plate assembly 1.

FIG. 3 shows melt conveying part 16, which is substantially annular in shape, separated from die plate assembly 1. On melt conveying part 16, the circular inlet 8 and adjoining flow channels 14 can also be seen on melt inlet side 4. In this embodiment, flow channels 14 are arranged next to each other in the shape of a ring.

It can be seen from the partial view of the die plate assembly 1 shown in FIG. 4 that outer ring 18 has a receiving section 24 for the melt conveying part 16 that is surrounded on the outside by outer ring 18. By means of receiving section 24, melt conveying part 16 is positioned longitudinally and radially in relation to the center axis L of die plate assembly 1. In the embodiment shown in FIG. 4, the receiving section 24 for melt conveying part 16 can be accessed from melt inlet side 4.

In the further alternative embodiment of a die plate assembly 1, shown in FIG. 5, the receiving section 24′ on outer ring 18′ can be accessed from melt outlet side 6. Melt conveying part 16′ is thus inserted from melt outlet side 6 into receiving section 24′. Receiving section 24′ is likewise designed to position melt conveying part 16 longitudinally and radially in relation to the center axis L of die plate assembly 1.

In FIG. 5, matching recesses 26, 26′ in the form of bore holes are also provided on outer ring 18′ and on melt conveying part 16′, and when die plate assembly 1 is in the assembled state, they are aligned with each other and configured to fasten outer ring 18′ and melt conveying part 16′ to each other by means of fastening means 27.

In the embodiments of die plate assembly 1 shown in FIGS. 4 and 5, outer rings 18, 18′ have a stepped recess 28, 28′ for forming receiving section 24, 24′. Each of recesses 28, 28′ includes a radially extending stop face 30, 30′ with which melt conveying part 16, 16′ comes into contact and is axially positioned when inserted into outer ring 18, 18′. In order to realize such a stop function, the melt conveying parts 16, 16′ shown in FIGS. 4 and 5 have at least one projection 32, 32′ that projects radially outwards and in this case is preferably circumferential. When mounting the separately embodied melt conveying parts 16, 16′, projection 32, 32′ rests with its abutment face 34, 34′ against the matching stop face 30, 30′ on outer ring 18, 18′.

The middle part 20 of the die plate assembly 1 shown in FIGS. 4 and 5 has a base member 36 and a guide cone 38 which can be connected to base member 36. By means of guide cone 38, the melt flowing towards die plate assembly 1 is distributed among the inlets 8 of die plate body 2, which are formed on melt conveying parts 16, 16′. The melt conveying parts 16, 16′ shown in FIGS. 4 and 5, respectively, each have a receptacle 40 for holding the middle part 20 on melt conveying part 16, 16′. Each receptacle 40 for middle part 20 can be accessed from melt outlet side 6. Receptacle 40 has a stepped recess 42 having a preferably radially extending receiving surface 44 for middle part 20. Middle part 20, in particular base member 36, has an outwardly protruding, preferably radially projecting projection 46 with an abutment face 48 that matches the receiving surface 44 on melt conveying part 16, 16′.

As can be seen by way of example from FIG. 5, base member 36 has an alignment element 50 for the guide cone 38 to be fastened thereto. Guide cone 38 is fastened to base member 36 by a plurality of fastening means 52, such as screws, thus clamping in place the section of the melt conveying part 16″ that has been received therebetween.

As can also be seen from FIGS. 4 and 5, at least one heating channel 54, which is offset radially inwards and radially outwards in relation to the flow channels 14 for the melt, is provided on melt conveying parts 16, 16′ in order to convey a heat medium therethrough. By means of the heat medium, heat energy is introduced in a targeted manner into the outlet region of flow channel 14 via heating channel 54, with the result that the plastic melt is kept in a free-flowing state inside the plurality of outlets 10 of melt conveying parts 16, 16′ of die plate assembly 1, which outlets have a reduced cross-section.

In the embodiments shown in FIGS. 4 and 5, a preferably circumferential air gap 25 is provided, at least in sections, between outer ring 18, 18′ and melt conveying part 16, 16′, and between melt conveying part 16, 16′ and middle part 20. In FIG. 4, material recesses 25′ are partly formed for that purpose on the inner wall region 94 of melt conveying part 16 or on the wall 95 of outer ring 18 facing melt conveying part 16. In FIG. 5, in contrast, material recesses are partly introduced into the inner and outer wall region 94, 94′ of melt conveying part 16′.

In the embodiment shown here, flow channel 14 transitions into a plurality of outlets 10, in this case four, having a significantly reduced cross-section and from which the respective melt strands exit on melt outlet side 6.

Outer rings 18, 18′ and melt conveying parts 16, 16′ have inlets and outlets 56, 56′, embodied as connection ports, for introducing the heat medium into heating channel 54 and for discharging the heat medium from heating channel 54. Each of the inlets and outlets 56, 56′ is connected to at least one heating pipe 112.

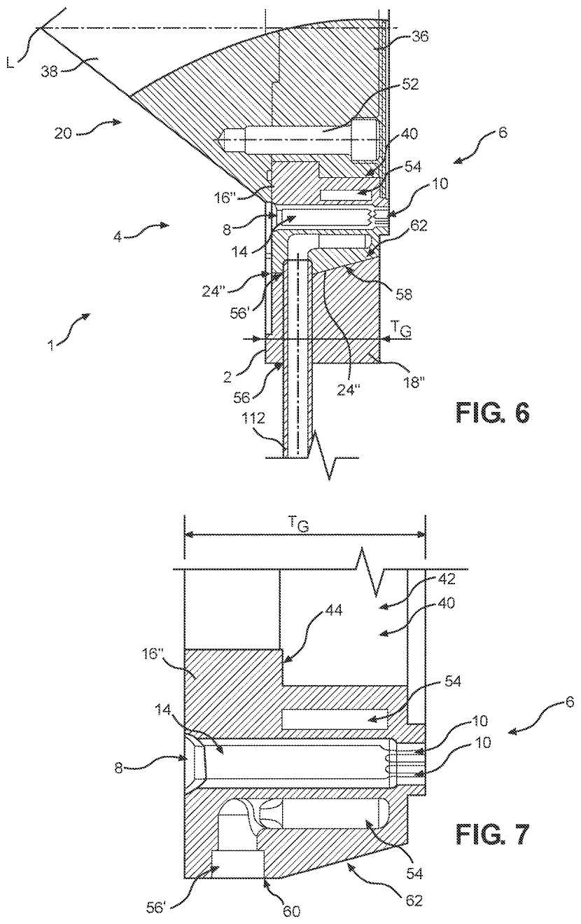

FIGS. 6 and 7 show another embodiment of a die plate assembly 1 according to the invention which, instead of a stepped recess as shown in the previous Figures, has on its outer ring 18″ a receiving section 24″ that has a receiving surface 58 which tapers conically from melt inlet side 4 towards melt outlet side 6. The conical receiving surface 58 extends over a section in the direction of the total depth TG of outer ring 18″. In this embodiment, melt conveying part 16″ can be inserted from the melt inlet side 4 into outer ring 18″. Along a section of its outer circumference 60, melt conveying part 16″ has an abutment face 62 that tapers conically from the melt inlet side in the direction of the melt outlet side and which matches the receiving surface 58 of receiving section 24″. As can be seen from FIG. 7, abutment face 62 preferably extends over about half of the total depth TG of melt conveying part 16″.

Reference is made, with regard to the design of the receptacle 40 on melt conveying part 16″ for middle part 20, and the design of the middle part 20 itself, to the comments in the foregoing concerning the embodiments shown in FIGS. 4 and 5. Material recesses 25′, not shown in further detail, may also be provided on abutment face 62 and also in the region of the receptacle 40 or recess in melt conveying part 16″ to form an air gap 25 to the adjacent regions of outer ring 18″ and middle part 20.

Reference is also made, with regard to the basic design of the melt conveying part 16″ of the matching outer ring 18″, to the embodiments described in the foregoing, for example with regard to flow channels 14, the inlets and outlets 8, 10 for the melt and with regard to heating channel 54 and its inlets and outlets 56, 56′ for the heat medium. As in the previous embodiments, heating channel 54 preferably extends along a section of flow channels 14 in melt conveying part 16″ and is assigned to the outlet end of flow channels 14. Heating channel 54 is also provided in the form of an annular space and extends adjacent to the annularly arranged flow channels 14 on both the inner side and the outer side.

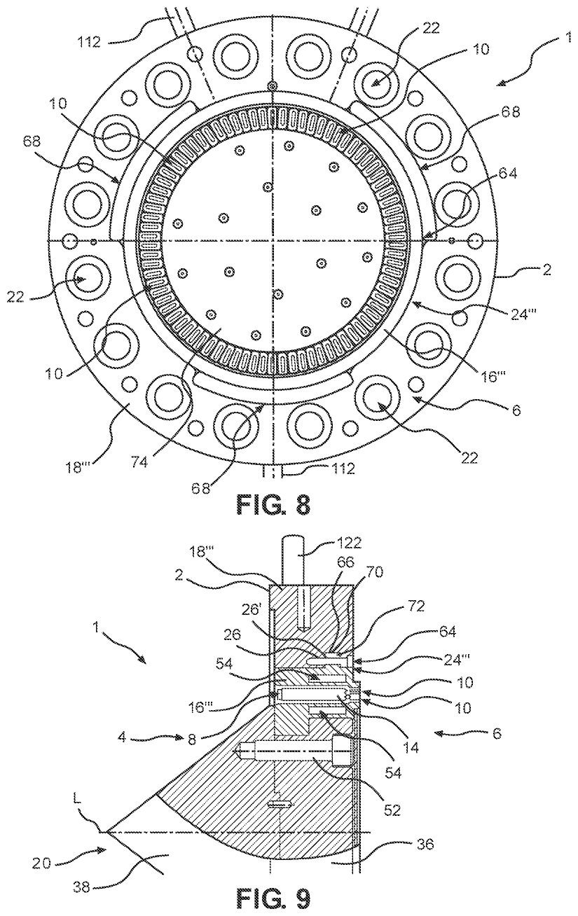

FIG. 8 shows another embodiment of a die plate assembly 1 having a multi-part die plate body 2, viewed from its melt outlet side 6. Die plate body 2 comprises a melt conveying part 16′″ and an outer ring 18′″ which are connected to each other by a rotary plug connection. Rotary plug connection 64 embodies another form of a receiving section 24′″ for the melt conveying part 16′″ on outer ring 18′″.

To form receiving section 24′″ as a rotary plug connection 64, at least one groove-like indentation 66 extending in the circumferential direction (FIG. 9) is embodied on outer ring 18′″, and outer ring 18′″ also has an axially open insertion region 68 which cooperates with the groove-like indentation 66 and is designed to receive a matching locking part 70 of melt conveying part 16′″. To insert melt conveying part 16′″ into outer ring 18′″, they are firstly moved axially towards each other until locking part 70 is aligned with groove-like indentation 66, and melt conveying part 16′″ and outer ring 18′″ are then rotated relative to one another about center axis L. A total of three such insertion regions 68 and matching groove-like indentations 66 are preferably provided on outer ring 18′″.

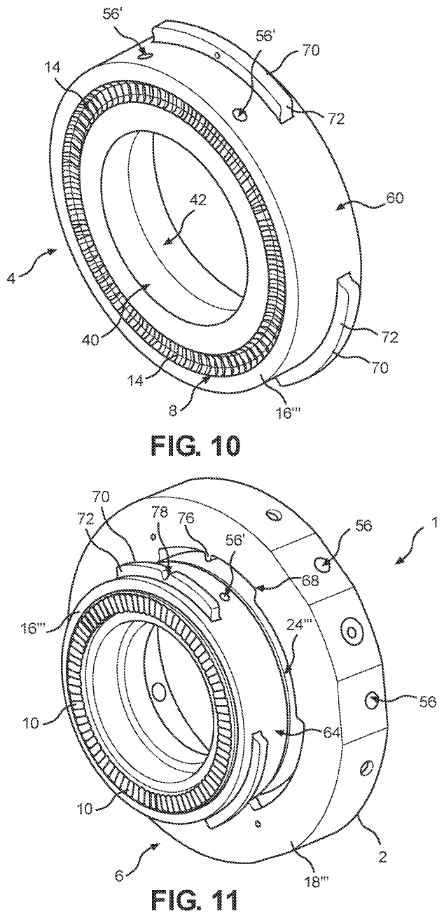

As FIG. 10 clearly illustrates, melt conveying part 16′″ has three material projections 72 on the outer circumference 60 of melt conveying part 16′″ that project radially from the outer circumference 60 of melt conveying part 16′″ and extend circumferentially to form locking parts 70. Each of material projections 72 are spaced axially apart from the melt inlet and melt outlet sides 4, 6 of melt conveying part 16′″. This embodiment allows melt conveying part 16′″ to be inserted from the melt outlet side 6 of the die plate assembly into outer ring 18′″. As can be seen from FIG. 8, the base member 36 of middle part 20 is covered on melt outlet side 6 by a cover plate 74. On the outside, around circular cover plate 74, under which insulation may be arranged, the outlets 10 arranged in the shape of a ring for the melt strands exiting on melt outlet side 6 can be seen. Outer ring 18′″ also has screw holders 22 for electrical fastening screws 108 to be inserted therein.

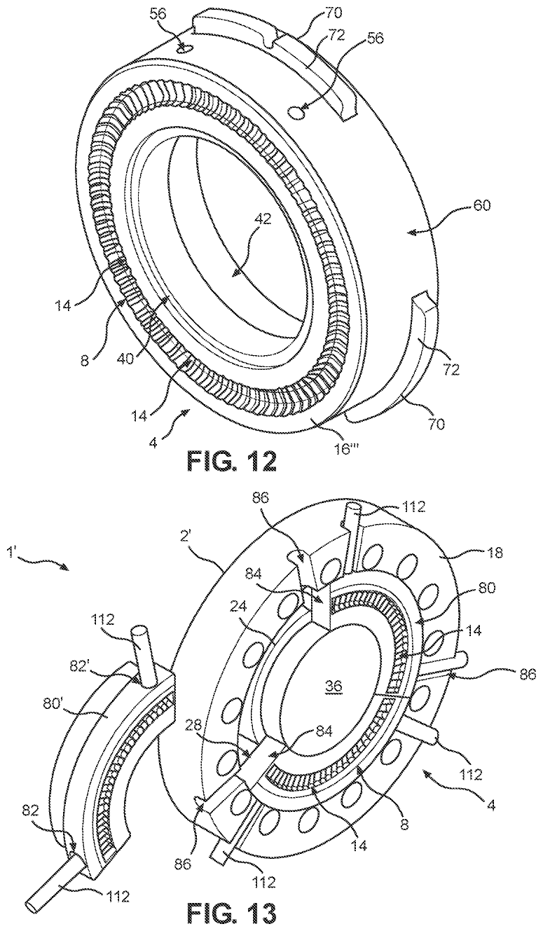

FIGS. 11 and 12 show a slightly modified variant of the embodiment shown in FIGS. 8-10. Matching form-fitting elements 76, 78 are formed as positioning means for outer ring 18′″ and melt conveying part 16′″ on outer ring 18′″ and on melt conveying part 16′″, in particular on one of the insertion regions 68 and also on one of the locking parts 70 provided in the form of material projections 72. By means of form-fitting elements 76, 78, outer ring 18′ and melt conveying part 16′″ can be joined together in one preferred direction only. This ensures that inlets and outlets 56, 56′ formed as connection ports for the heat medium in melt conveying part 16′″ and also in outer ring 18′″ are aligned with each other after the two components have been joined together, thus preventing them from being assembled incorrectly.

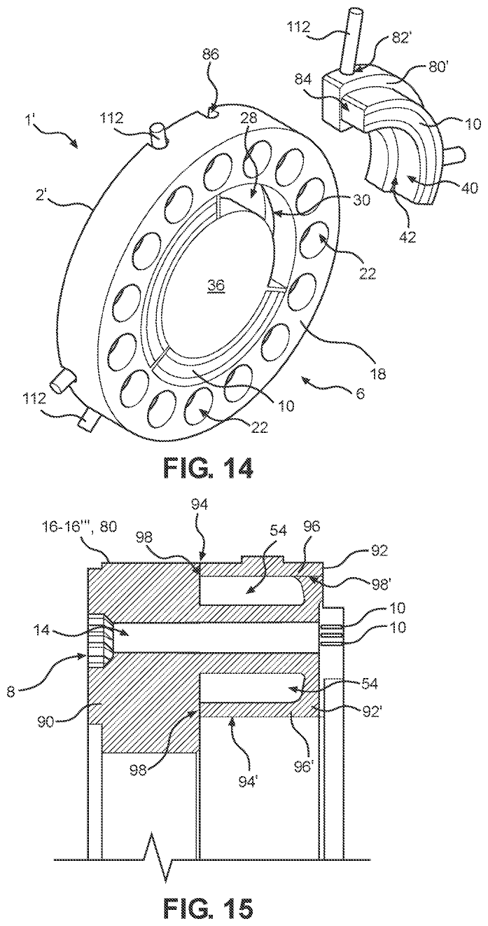

FIGS. 13 and 14 show another embodiment of a die plate assembly 1′ according to the invention, which instead of an integral melt conveying part 16 has a melt conveying part 80 that is subdivided into a plurality of segments 80′, preferably ring segments. In the embodiment shown here, melt conveying part 80 is divided into three segments 80′. Each segment 80′ has a connection port as an inlet 82 to heating channel 54 and at least one further connection port as an outlet 82′ for the heat medium out of the heating channel. Each segment 80′ is thus supplied with the heat medium that is needed to heat up the plastic melt and that flows through the respective heating channel 54.

Outer ring 18 of die plate assembly 1′ has a receiving section 24 for the melt conveying part 80 surrounded on the outside by outer ring 18. To form the receiving section 24, outer ring 18 has a stepped recess 28. Recess 28 includes a radially extending stop face 30 with which melt conveying part 80, in particular segments 80′ thereof, come into contact when inserted into outer ring 18.

The end faces 84 of segments 80′ are designed or arranged to form a seal against each other, so that the plastic melt is prevented from passing between segments 80′ when such a die plate assembly 1′ is in operation.

As can also be seen from FIGS. 13 and 14, the heating pipes 112 for the heat medium are connected directly to each segment 80′. In order that the segments 80′ thus formed can be inserted into outer ring 18, outer ring 18 has extending radially recesses 86 on its melt inlet side 4, into which heating pipes 112 are inserted together with the segments 80′ in outer ring 18.

With regard to the design of the receptacle 40 for middle part 20 on melt conveying part 16″ in FIGS. 8-12, or on melt conveying part 80 in FIGS. 13 and 14, and with regard to the design of the middle part 20 itself, reference is made to the comments in the foregoing concerning the embodiments shown in FIGS. 4 and 5.

Reference is also made, with regard to the basic design of the melt conveying part 16″ of the matching outer ring 18″, to the embodiments described in the foregoing, for example with regard to flow channels 14, the inlets and outlets 8, 10 for the melt, and with regard to heating channel 54 to the inlets and outlets 56, 56′, embodied as connection ports, for the heat medium. As in the previous embodiments, heating channel 54 preferably extends along a section of flow channels 14 in melt conveying part 16″ and is assigned to the outlet end of flow channels 14. Heating channel 54 is also provided in the form of an annular space and extends adjacent to the annularly arranged flow channels 14 on both the inner side and the outer side.

In one embodiment of the invention, melt conveying parts 16-16′″, 80 can be produced using an additive manufacturing method, in particular a three-dimensional printing method. This means that melt conveying parts 16-16′″, 80 can be integrally embodied, with all their recesses, undercuts and cavities.

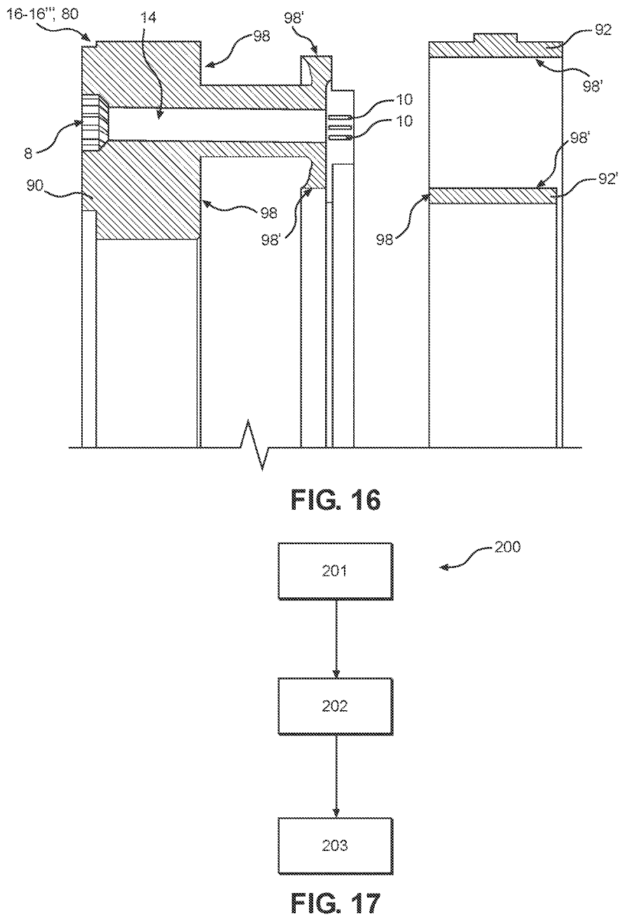

In one possible embodiment of the invention, the melt conveying part is produced using conventional manufacturing and machining methods, in such a way that the melt conveying part 16-16′″, 80 according to FIGS. 15 and 16 is embodied in multiple parts. As can be seen from FIGS. 15 and 16, melt conveying part 16-16′″, 80 has at least one base member 90 comprising inlet 8, outlets 10 and flow channels 14, and two separately embodied, approximately cylindrical sleeve members 92, 92′. Sleeve members 92, 92′ each delimit an inner or outer wall region 94, 94′ of melt conveying part 16-16′″. Sleeve members 92, 92′ also define the outer walls 96, 96′ of heating channel 54 facing away from flow channels 14.

In one embodiment of the invention, sleeve members 92, 92′ are sealingly connected at their contact surfaces 98, 98′ to regions of the base member 90 of melt conveying part 16-16′″, 80, as can be realized, for example, with the aid of sealing elements arranged on base member 90. In another embodiment, a form-fitting connection is created in the region of contact surfaces 90, 96; in particular, the contact surfaces are welded to each other.

Furthermore, a preferred embodiment of a method 200 for repairing a pelletizing apparatus 100 having a die plate assembly 1, 1′ is shown in the form of a block diagram in FIG. 17. The method 200 according to the invention is used, in particular, to dismantle the separately formed melt conveying part 16-16′″, 80 shown in FIGS. 1-16 from a die plate assembly 1, 1′ for a pelletizing apparatus 100 and to mount it again after reconditioning, or to replace it with another separate melt conveying part 16-16′″, 80.

In a first step 201, die plate assembly 1, 1′ is at least partly dismantled. Either the entire die plate assembly on a pelletizing apparatus 100 can be dismantled, or only parts of die plate assembly 1, 1′, in particular the melt conveying part 16′, 16′″ on die plate body 2, which can be removed from die plate body 2 from the melt outlet side 6.

In a subsequent step 202, the melt conveying part 16-16′″ of die plate assembly 1, 1′ is replaced. Melt conveying part 16-16′″ can be replaced as an entire part, or it is also possible to replace only segments 80′ of such a melt conveying part 80 on die plate body 2, 2′.

In step 203, finally, at least one part of die plate assembly 1, 1′ fitted with a new melt conveying part 16-16′″, 80 or segment 80′ is mounted on a die plate holder or the pelletizing apparatus, whereby parts of die plate assembly 1, 1′ are preferably dismantled and mounted from the melt outlet side 6 of the die plate assembly.

When dismantling and mounting at least the melt conveying part 16, 16′″, 80 on die plate body 2, 2′, it is normally removed together with the middle part 20 on die plate assembly 1, 1′, and the melt conveying part 16, 16′″, 80 and middle part 20 are also reinserted together on the outer ring 18-18′″ of the die plate assembly.

### LIST OF REFERENCE SIGNS

1, 1′ Die plate assembly
2, 2′ Die plate body
4 Melt inlet side
6 Melt outlet side
8 Inlet
10 Outlet
12 Melt conveying zone
14 Flow channel
16, 16′; 16″, 16′″, Melt conveying part
18, 18′, 18″, 18′″ Outer ring
20 Middle part
22 Screw holder
24, 24′, 24″, 24′″ Receiving section
25 Air gap
25′ Material recess
26, 26′ Recess
27, 52 Fastening means
28, 28′ Recess
30, 30′ Stop face
32, 32′ Projection
34, 34′ Abutment face
36 Base member
38 Guide cone
40 Receptacle
42 Recess
44 Receiving surface
46 Projection
48 Abutment face
50 Alignment element
54 Heating channel
56, 56′ Inlet and outlet
58 Receiving surface
60 Outer circumference
62 Abutment face
64 Rotary plug connection
66 Indentation
68 Insertion region
70 Locking part
72 Material projection
74 Cover plate
76, 78 Form-fitting element
80 Melt conveying part
80′ Segment
82, 82′ Inlet and outlet
84 End face
86 Recess
90 Base member
92, 92′ Sleeve member
94, 94′ Wall region
95 Inner wall of outer ring
96, 96′ Wall
98, 98′ Contact surface
100 Pelletizing apparatus
102 Underwater pelletizer
104 Drive means
106 Protective cover
108 Fixing screws
112 Heating pipe
114 Process water inlet
116 Process water outlet
118 Machine base
120 Spacer elements
122 Housing structure
200 Method
201 Dismantling step
202 Replacement step
203 Mounting step
L Centre axis
TG Total depth

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1-60. (canceled)

61. A die plate assembly for a pelletizing apparatus for producing granulate from liquid plastic melt, the die plate assembly comprising:
at least one inlet arranged on a melt inlet side for feeding in melt, and a plurality of outlets arranged on a melt outlet side for dispensing the melt,
a melt conveying zone having at least one melt flow channel extending from the melt inlet side to the melt outlet side,
wherein the melt conveying zone is designed as a melt conveying part which is separable from the die plate assembly and can be reversibly mounted on and dismantled from the die plate assembly.

62. The die plate assembly according to claim 61,
wherein the die plate assembly is formed by at least the melt conveying part and at least one of a middle part and an outer ring, wherein the melt conveying part can be releasably coupled to the at least one of the middle part and the outer ring.

63. (canceled)

64. The die plate assembly according to claim 62,
wherein the outer ring of the die plate assembly has a receiving section for the melt conveying part to be positioned relative to the outer ring.

65. The die plate assembly according to claim 64,
wherein the receiving section for the melt conveying part can be accessed from the melt inlet side or the melt outlet side.

66. The die plate assembly according to claim 64,
wherein, to form the receiving section, the outer ring has a recess with a stop face for the melt conveying part extending approximately in a radial direction.

67. The die plate assembly according to claim 66,
wherein the melt conveying part has at least one projection projecting radially outwards and having an abutment face matching the stop face on the outer ring.

68. The die plate assembly according to claim 64,
wherein the outer ring has a receiving surface tapering conically from the melt inlet side towards the melt outlet side to form the receiving section.

69. The die plate assembly according to claim 68,
wherein the melt conveying part has an abutment face tapering conically from the melt inlet side towards the melt outlet side and defining a section on an outer circumference, and which matches the receiving surface on the outer ring.

70. The die plate assembly according to claim 64,
wherein the receiving section on the outer ring is designed as a rotary plug connection having at least one groovelike indentation extending in a circumferential direction and an axially open insertion region for a locking part on the melt conveying part for insertion into the indentation via the insertion region.

71. The die plate assembly according to claim 70,
wherein the melt conveying part has at least one projection spaced axially apart from the melt inlet and melt outlet side of the melt conveying part and projecting radially from an outer circumference and extending circumferentially along a section to form the locking part.

72. (canceled)

73. The die plate assembly according to claim 62,
wherein matching recesses are provided on the outer ring and on the melt conveying part, which in operation are axially aligned with one another and are arranged to fix the outer ring and the melt conveying part to one another.

74. The die plate assembly according to claim 73,
wherein the at least one of the melt conveying part and the outer ring has at least one heating channel offset radially relative to the melt flow channels, for conveying a heat medium therethrough, or a heating conductor receptacle for inserting an electrical heating conductor.

75. (canceled)

76. The die plate assembly according to claim 74,
wherein the at least one heating channel is an annular space and the melt conveying part has at least one inlet for the heat medium into the heating channel and at least one outlet for the heat medium out of the heating channel.

77. The die plate assembly according to claim 61,
wherein the melt conveying part has at least one base member surrounding the flow channels and at least one separately embodied, approximately cylindrical sleeve member which delimits at least one wall region of the melt conveying part.

78. (canceled)

79. The die plate assembly according to claim 61,
wherein the melt conveying part is subdivided into at least two separate segments.

80. (canceled)

81. The die plate assembly according to claim 62,
wherein the melt conveying part has a receptacle for holding the middle part on the melt conveying part.

82. The die plate assembly according to claim 81,
wherein the receptacle for the middle part can be accessed from the melt outlet side and has at least one stepped recess with a radially extending receiving surface for the middle part.

83. (canceled)

84. The die plate assembly according to claim 62,
wherein the middle part is composed of a substantially cylindrical base member and a guide cone which can be connected to the base member, wherein the middle part has at least one alignment element for the guide cone to be received on the base member.

85. The die plate assembly according to claim 62,
wherein an air gap is formed at least in sections between the melt conveying part and one of the outer ring and the middle part.

86. The die plate assembly according to claim 62,
wherein the at least one of the outer ring and the middle part is made of a material which has a low coefficient of thermal conductivity relative to the material used to form the melt conveying part.

87-90. (canceled)
